(19) United States
(12) Patent Application Publication
(10) Pub. No.: US 2011/0103183 A1
(43) Pub. Date: May 5, 2011

(54) System and Technique to Increase the Spacing of Particle Motion Sensors on a Seismic Streamer

(76) Inventors: Ahmet Kemal Ozdemir, Asker (NO); Lars Borgen, Sande (NO)

(21) Appl. No.: 12/611,626

(22) Filed: Nov. 3, 2009

(51) Int. Cl. G01V 1/38; G01V 1/36

(52) U.S. Cl. 367/24

(57) ABSTRACT

A technique includes receiving data indicative of non-uniformly spaced samples of particle motion wavefield acquired by particle motion sensors while in tow. The samples are spaced apart by an average spacing interval, which is not small enough to prevent vibration noise from being aliased into a signal cone for a first signal formed from samples of the particle motion wavefield having a uniform spacing at the average spacing interval. The technique includes processing the data to generate a second signal that is indicative of the particle motion wavefield and does not have aliased vibration noise in the signal cone.

### BACKGROUND

The invention generally relates to a system and technique to increase the spacing of particle motion sensors on a seismic streamer.

Seismic exploration involves surveying subterranean geological formations for hydrocarbon deposits. A survey typically involves deploying seismic source(s) and seismic sensors at predetermined locations. The sources generate seismic waves, which propagate into the geological formations creating pressure changes and vibrations along their way. Changes in elastic properties of the geological formation scatter the seismic waves, changing their direction of propagation and other properties. Part of the energy emitted by the sources reaches the seismic sensors. Some seismic sensors are sensitive to pressure changes (hydrophones), others to particle motion (e.g., geophones and/or accelerometers), and industrial surveys may deploy only one type of sensor or both. In response to the detected seismic events, the sensors generate electrical signals to produce seismic data. Analysis of the seismic data can then indicate the presence or absence of probable locations of hydrocarbon deposits.

Some surveys are known as “marine” surveys because they are conducted in marine environments. However, “marine” surveys may be conducted not only in saltwater environments, but also in fresh and brackish waters. In one type of marine survey, called a “towed-array” survey, an array of seismic sensor-containing streamers and sources is towed behind a survey vessel.

### SUMMARY

In an embodiment of the invention, a technique includes receiving data indicative of non-uniformly spaced samples of particle motion wavefield acquired by particle motion sensors while in tow. The samples are spaced apart by an average spacing interval, which is not small enough to prevent vibration noise from being aliased into a signal cone for a first signal formed from samples of the particle motion wavefield having a uniform spacing at the average spacing interval. The technique includes processing the data to generate a second signal that is indicative of the particle motion wavefield and does not have aliased vibration noise in the signal cone.

Advantages and other features of the invention will become apparent from the following drawing, description and claims.

### BRIEF DESCRIPTION OF THE DRAWING

FIG. 1 is a schematic diagram of a marine-based seismic acquisition system according to an embodiment of the invention.

FIG. 2 is an illustration of the frequency-wavenumber spectrum in the continuous domain of a synthetically generated signal sensed by towed particle motion sensors.

FIG. 3 is an illustration of the frequency-wavenumber spectrum of a signal formed from uniformly-spaced samples acquired by towed particle motion sensors for the case where the sampling interval is small enough to prevent vibration noise from aliasing into the signal cone.

FIG. 4 is an illustration of the frequency-wavenumber spectrum of a signal formed from uniformly-spaced samples acquired by towed particle motion sensors for the case where the sampling interval is not small enough to prevent vibration noise from being aliased into the signal cone.

FIGS. 5 and 13 are flow diagrams depicting techniques to process data acquired by non-uniformly-spaced towed particle motion sensors to generate a signal that does not contain aliased vibration noise in the signal cone according to embodiments of the invention.

FIG. 6 is an illustration of the impulse response of a digital half-band filter according to an embodiment of the invention.

FIG. 7 is an illustration of the wavenumber response of the digital half-band filter according to an embodiment of the invention.

FIG. 8 is an illustration of the frequency-wavenumber spectrum of a signal derived by applying the digital half-band filter to the signal whose frequency-wavenumber spectrum is depicted in FIG. 3 according to an embodiment of the invention.

FIG. 9 is an illustration of the frequency-wavenumber spectrum of a signal derived by downsampling the signal whose frequency-wavenumber spectrum is depicted in FIG. 8 according to an embodiment of the invention.

FIG. 10 is an illustration of the frequency-wavenumber spectrum of signal obtained by frequency-wavenumber filtering the signal whose frequency-wavenumber spectrum is depicted in FIG. 9 according to an embodiment of the invention.

FIG. 11 is a schematic diagram of a streamer illustrating a non-uniform and regular spacing of particle motion sensors along the streamer according to an embodiment of the invention.

FIG. 12 is an illustration of the frequency-wavenumber spectrum of a signal derived by frequency-wavenumber filtering the signal whose frequency-wavenumber spectrum is depicted in FIG. 4 according to an embodiment of the invention.

FIG. 14 is a schematic diagram of a data processing system according to an embodiment of the invention.

### DETAILED DESCRIPTION

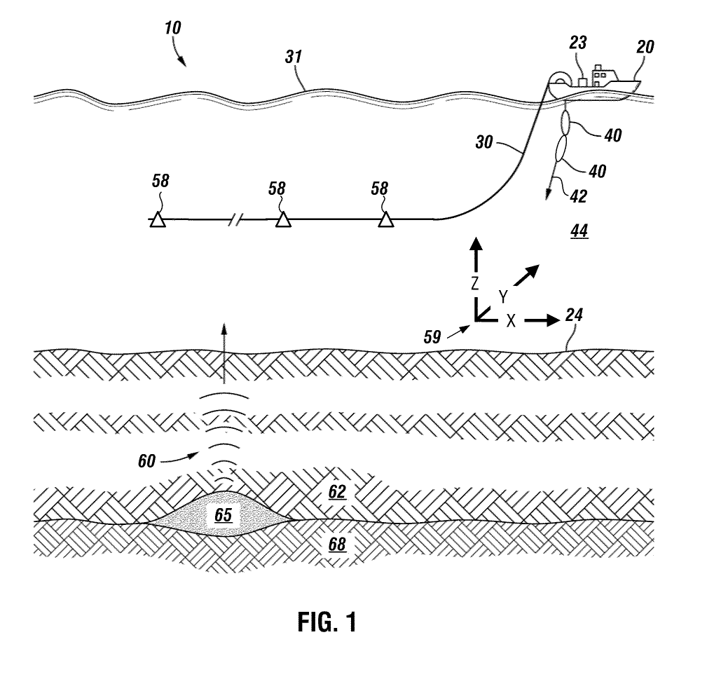

FIG. 1 depicts an embodiment 10 of a marine-based seismic data acquisition system in accordance with some embodiments of the invention. In the system 10, a survey vessel 20 tows one or more seismic streamers 30 (one exemplary streamer 30 being depicted in FIG. 1) behind the vessel 20. In one non-limiting example, the streamers 30 may be arranged in a spread in which multiple streamers 30 are towed in approximately the same plane at the same depth. As another non-limiting example, the streamers may be towed at multiple depths, such as in an over/under spread, for example.

Each seismic streamer 30 may be several thousand meters long and may contain various support cables (not shown), as well as wiring and/or circuitry (not shown) that may be used to support communication along the streamers 30. In general, the streamer 30 includes a primary cable into which is mounted seismic sensors that record seismic signals.

In accordance with embodiments of the invention, the streamer 30 is a multi-component streamer, which means that the streamer 30 contains particle motion sensors 58 and pressure sensors (not shown in FIG. 1). Each pressure sensor is capable of detecting a pressure wavefield, and each particle motion sensor 58 is capable of detecting at least one component of a particle motion that is associated with acoustic signals that are proximate to the sensor 58. Examples of particle motions include one or more components of a particle displacement, one or more components (inline (x), crossline (y) and vertical (z) components (see axes 59, for example)) of a particle velocity and one or more components of a particle acceleration.

Depending on the particular embodiment of the invention, the streamer 30 may include hydrophones, geophones, particle displacement sensors, particle velocity sensors, accelerometers, pressure gradient sensors, or combinations thereof.

As a non-limiting example, in accordance with some embodiments of the invention, the particle motion sensor 58 measures at least one component of particle motion along a particular sensitive axis 59 (the x, y or z axis, for example). As a more specific example, the particle motion sensor 58 may measure particle velocity along the depth, or z, axis; particle velocity along the crossline, or y, axis; and/or velocity along the inline, or x, axis. Alternatively, in other embodiments of the invention, the particle motion sensor(s) 58 may sense a particle motion other than velocity (an acceleration, for example).

In addition to the streamer(s) 30 and the survey vessel 20, the marine seismic data acquisition system 10 also includes one or more seismic sources 40 (two exemplary seismic sources 40 being depicted in FIG. 1), such as air guns and the like. In some embodiments of the invention, the seismic source(s) 40 may be coupled to, or towed by, the survey vessel 20. Alternatively, in other embodiments of the invention, the seismic source(s) 40 may operate independently of the survey vessel 20, in that the source(s) 40 may be coupled to other vessels or buoys, as just a few examples.

As the seismic streamers 30 are towed behind the survey vessel 20, acoustic signals 42 (an exemplary acoustic signal 42 being depicted in FIG. 1), often referred to as “shots,” are produced by the seismic source(s) 40 and are directed down through a water column 44 into strata 62 and 68 beneath a water bottom surface 24. The acoustic signals 42 are reflected from the various subterranean geological formations, such as an exemplary formation 65 that is depicted in FIG. 1.

The incident acoustic signals 42 that are created by the seismic source(s) 40 produce corresponding reflected acoustic signals, or pressure waves 60, which are sensed by the towed seismic sensors. It is noted that the pressure waves that are received and sensed by the seismic sensors include “up going” pressure waves that propagate to the sensors without reflection, as well as “down going” pressure waves that are produced by reflections of the pressure waves 60 from an air-water boundary, or free surface 31.

The seismic sensors generate signals (digital signals, for example), called “traces,” which indicate the acquired measurements of the pressure and particle motion wavefields. The traces are recorded and may be at least partially processed by a signal processing unit 23 that is deployed on the survey vessel 20, in accordance with some embodiments of the invention. For example, a particular pressure sensor may provide a trace, which corresponds to a measure of a pressure wavefield by its hydrophone; and a given particle motion sensor 58 may provide (depending on the particular embodiment of the invention) one or more traces that correspond to one or more components of particle motion.

The goal of the seismic acquisition is to build up an image of a survey area for purposes of identifying subterranean geological formations, such as the exemplary geological formation 65. Subsequent analysis of the representation may reveal probable locations of hydrocarbon deposits in subterranean geological formations. Depending on the particular embodiment of the invention, portions of the analysis of the representation may be performed on the seismic survey vessel 20, such as by the signal processing unit 23. In accordance with other embodiments of the invention, the representation may be processed by a data processing system that may be, for example, located on land, on a streamer 30, distributed on several streamers 30, on a vessel other than the vessel 20, etc.

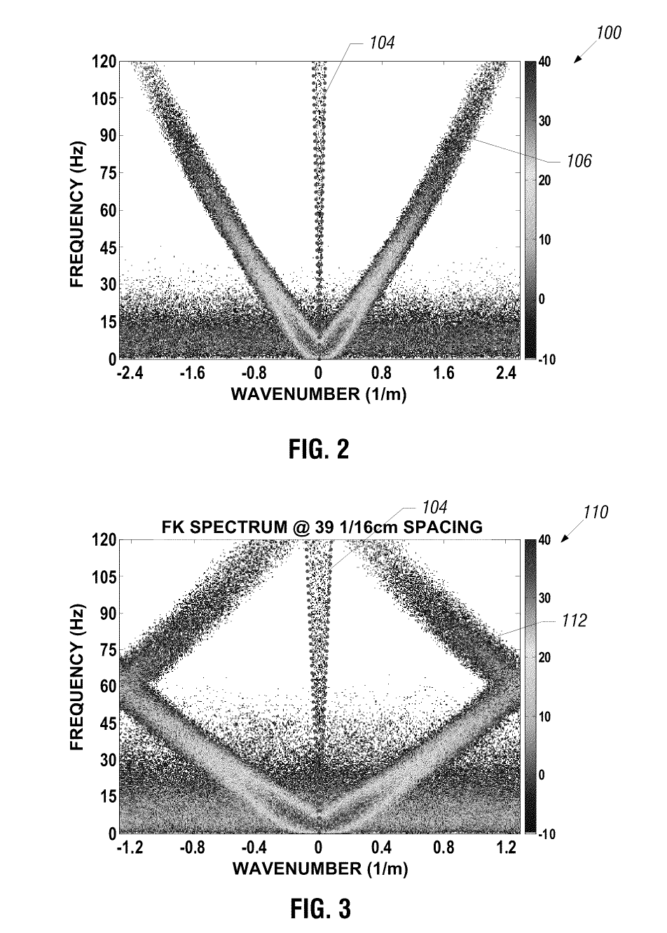

The measurement acquired by the particle motion sensor 58 has at least two components: a desired signal indicative of the measured particle motion; and vibration noise, which is attributable to the sensitivity of the sensor 58 to vibration of the streamer cable. Referring to FIG. 2, which is an illustration 100 of the frequency-wavenumber (f-k) spectrum in the continuous domain of a synthetically generated signal sensed by particle motion sensors, the desired portion of the signal (which indicates the sensed particle motion) is contained within a region in f-k space called a “signal cone 104.” The illustration depicts broadband noise at the lower frequencies, which may be attributable to the turbulent flow outside of the streamer. The dominant noise energy, as shown in FIG. 2 is the coherent transversal vibration noise 106, called “vibration noise,” herein.

In the synthetically generated f-k spectrum depicted in FIG. 2, the propagation velocity of the vibration noise was chosen to be about 15 meters per second (m/s) to simulate the transversal vibration noise at the tail of a gel-filled streamer cable. In general, for a gel-filled streamer, the velocity of the vibration noise is proportional to the square root of the tension in the cable. Therefore, the transversal vibration noise propagates faster at the front end of the cable. For a solid streamer, the velocity of the vibration noise is proportional to the square of the tension at lower frequencies and proportional to the square root of the bending stiffness of the cable material at higher frequencies. For a streamer that has a relatively soft cable and is at a relatively low tension (such as at the tail end of the cable, for example), the vibration noise has a lower propagation velocity.

The particle motion wavefield and vibration noise are sampled in space by the particle motion sensors 58 at the various particle motion sensor positions along the streamer 30. The vibration noise that is acquired by the particle motion sensors 58 is spatially aliased if the particle motion sensor spacing is larger than the inverse of the spatial Nyquist wavenumber rate for proper sampling of the vibration noise. This aliasing may be tolerated as along as the aliased vibration noise does not overlap with the sensed particle motion signal (i.e., as long as the aliased vibration noise does not enter the signal cone 104). Vibration noise that aliases into the signal cone 104 masks the underlying particle motion signal because of the relatively high energy of the vibration noise. Therefore, measures are undertaken to avoid the aliasing of the vibration noise into the signal cone 104.

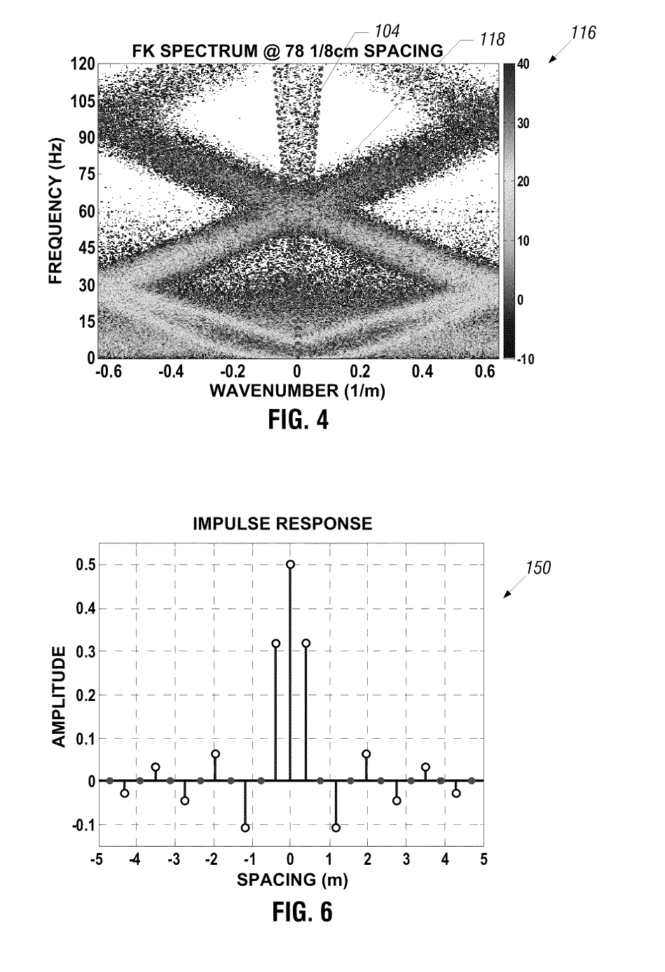

A traditional approach to avoid aliasing the vibration noise into the signal cone 104 is to use relatively closely-spaced particle motion sensors: uniformly-spaced samples that are acquired at points along a regular grid (where the “grid” may be one-dimensional (1-D) for the case of a single streamer 30). FIGS. 3 and 4 depict illustrations 110 and 116, respectively, of the f-k spectrums of particle motion data acquired at different sensor spacings. More specifically, FIG. 3 illustrates the f-k spectrum of a signal formed from uniformly and regularly spaced samples acquired by particle motion sensors, where the sampling interval was sufficiently small to prevent aliased vibration noise 112 from entering the signal cone 104. As a comparison, FIG. 4 illustrates the f-k spectrum of a signal formed from uniformly and regularly spaced samples acquired by particle motion sensors, where the sampling interval was not small enough to prevent aliased vibration noise 118 from entering the signal cone 104.

As can be seen from the example above, a conventional solution to prevent the aliased vibration noise from entering the signal cone is to densely space the particle motion sensors along the streamer. However, this is a relatively expensive solution, because the average sensor spacing interval to properly sample the particle motion wavefield is significantly greater than the spacing interval that is required to properly sample the vibration noise.

Processing techniques are described herein, which allow a larger average spacing for the particle motion sensors 58 while still preventing aliased vibration noise from entering the signal cone 104. These processing techniques are based on a regular and non-uniform sampling spacing of the particle motion sensors, as compared to the regular and uniform sampling described above. More specifically, the processing assumes that the particle motion sensor measurements are acquired at points on a regular and non-uniform grid. In other words, each pair of adjacent particle motion sensors 58 is not necessarily spaced apart by the same spacing interval. However, the spacing sequence is regular in nature.

The grid is defined by points that are regularly spaced apart by a distance that is equal to or slightly less than the maximum spacing that is required to prevent the vibration noise from aliasing into the signal cone 104 if the samples taken at each of the points in the grid were processed to reconstruct the composite signal. However, in accordance with embodiments of the invention, which are disclosed herein, the processed samples are non-uniformly spaced among the points in the grid. As a result of this processing, the average particle motion sensor spacing interval is significantly larger than the corresponding particle motion sensor spacing interval that is required for uniform sampling. Therefore, the techniques and systems that are disclosed herein are less expensive than traditional approaches in that a fewer number of particle motion sensors are required.

Techniques and systems that are disclosed herein apply to both gel-filled and solid streamers so that the streamers may have larger average sensor spacings than traditional streamers. The techniques and systems that are disclosed herein may likewise be applied to solid streamers to allow the use of a lower cable bending stiffness with a given average sensor distance.

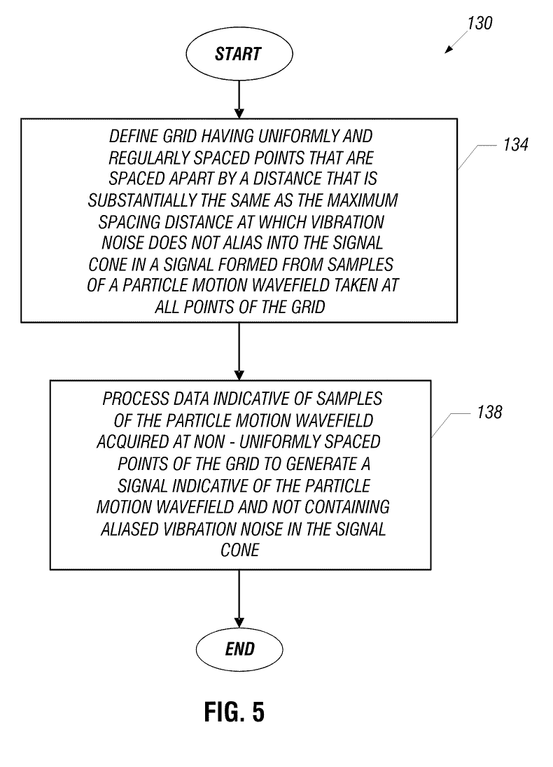

Referring to FIG. 5, in accordance with embodiments of the invention, a technique 130 includes defining (block 134) a grid that has uniformly and regularly spaced points that are spaced apart by a distance that is substantially the same as the maximum spacing distance at which vibration noise does not alias into the signal cone in a signal that is formed from samples of a particle motion wavefield, which are taken at all points of the grid. Samples at all points of the grid are not, however, taken or processed. Instead, the technique includes processing (block 138) data indicative of samples of the particle motion wavefield acquired at non-uniformly spaced points of the grid to generate a signal that is indicative of the particle motion wavefield and does not contain aliased vibration noise.

As further described below, the processing technique that is disclosed herein applies a half-band digital filter to the acquired particle motion data, in accordance with some embodiments of the invention. The half-band filter is a type of finite impulse response (FIR) filter with a cut-off wavenumber that is centered at half of the Nyquist wavenumber, which is the highest wavenumber that may be reconstructed by using a given sample spacing interval. In other words, if the spacing interval between the coefficients of the filter is “Δx,” then the cut-off wavenumber of the half-band filter is “1/(4Δx).” An important property of the half-band-filter is that almost half of the coefficients of the filter are zero.

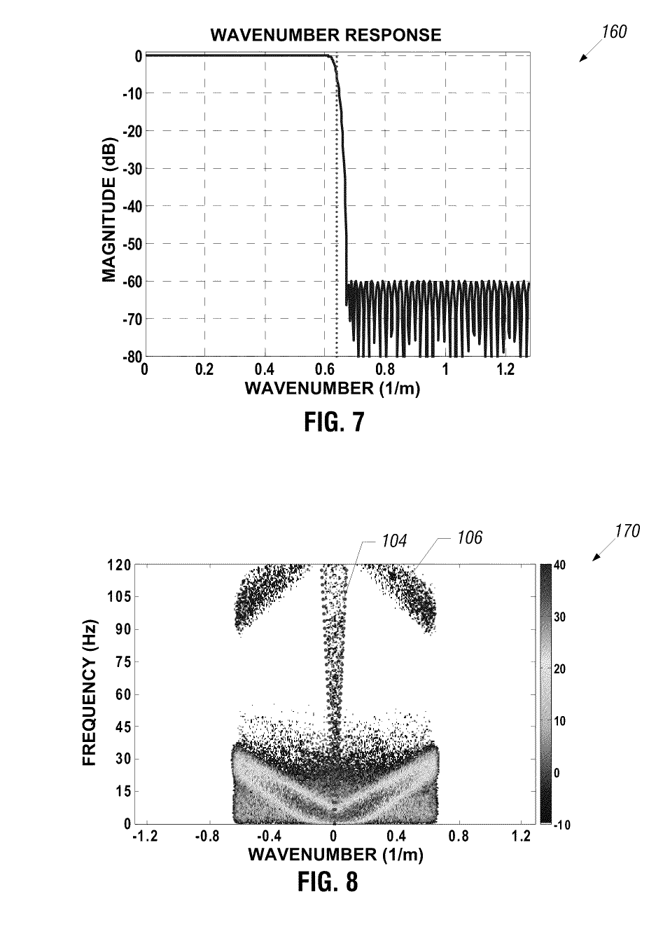

More specifically, FIG. 6 depicts an exemplary impulse response 150 of a digital half-band filter. As can be seen, approximately half of the coefficients of the impulse response 150 are zero. These zero coefficients occur at the even indices, with the exception being that at zero spacing, the amplitude of the impulse response 150 is non-zero. As depicted in FIG. 7, a wavenumber response 160 of the digital half-band filter may be set with a particular cut-off wavenumber. For this particular example, the cut-off wavenumber is 0.6.

The digital half-band filter may be applied to the particle motion data to filter wavenumbers out, which are above a particular cut-off wavenumber. Because the half-band filter has an impulse response with zero coefficients at approximately one half of its input, the filter effectively reduces, or decimates, the sampling rate of the input signal.

FIG. 8 depicts the f-k spectrum of an output signal of the half-band filter, where the half-band filter filters the signal whose f-k spectrum is illustrated in FIG. 3. As illustrated by the comparison of FIGS. 3 and 8, the half-band filter attenuates wavenumbers above 0.6 in this example.

As also illustrated in FIG. 8, the application of the half-band filter removes the aliased vibration noise component that is located in the approximate 50 to 80 Hz frequency band for this example. However, the filtering does not attenuate the desired particle motion sensor or the aliased vibration noise components at frequencies approximately above 80 Hz or below 50 Hz.

Mathematically, the filtering operation may be expressed as a convolution between the filter's impulse response and its input data, as described below:

$$p ( m Δ t , n Δ x ) = {\sum }_{{n}^{′}} {h}_{{n}^{′}} s ( m Δ t , ( n - {n}^{′} ) Δ x ) , \qquad Eq . 1$$

where “p(mΔt,nΔx)” represents the output of the half-band filter; “m” represents the index of the time sample; “n” represents the index of the trace; “s(mΔt,nΔx)” represents the input data to the half-band filter; and “hₙ” represents the n-th coefficient of the impulse response of the half-band filter. It is noted that the half-band filter is only applied in the space dimension.
As noted above, all even indexed coefficients of the half-band filter for this example are zero, except for the one at n=0. Therefore, the convolution described above in Eq. 1 may alternatively be described as follows:

$$p ( m Δ t , n Δ x ) = {h}_{0} s ( m Δ t , 0 ) + {\sum }_{{n}^{′}} {h}_{{n}^{′}} s ( m Δ t , ( n - 2 {n}^{′} - 1 ) Δ x ) . \qquad Eq . 2$$

Therefore, to compute the output signal at a given indexed position, the half-band filter only requires half of the indexed input traces and the input trace at which the output is to be computed.

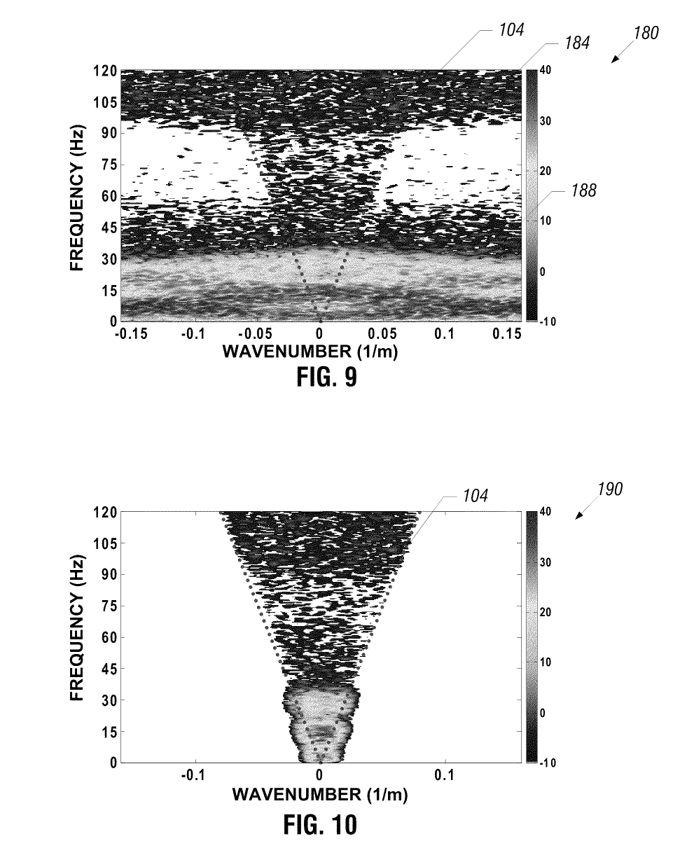

To further increase the average spacing of the particle motion sensors 58, the output data of the half-band filter may be downsampled. More specifically, FIG. 9 depicts a non-limiting example in which the output data from the half-band filter was downsampled by a factor of eight. In this regard, FIG. 9 depicts an illustration 180 of the f-k spectrum of the output signal of the digital half-band filter after downsampling by eight. In other words, every other seven samples in the output signal were discarded, which relaxed the corresponding spacing of the input signal. As depicted in FIG. 9, the vibration noise components which are located at frequencies below approximately 50 Hz (at reference numeral 188) and approximately above 80 Hz (at reference numeral 184) wrap around in wavenumber and alias into the signal cone 104. However, there is no vibration noise (aliased or non-aliased) at frequencies between approximately 50 and 80 Hz, as the vibration noise at these frequencies was removed by the half-band filter.

Mathematically, the downsampling may be described as follows:

$$q ( m Δ t , ( 2 Mn + 1 ) Δ x ) = {h}_{0} s ( m Δ t , 0 ) + {\sum }_{{n}^{′}} {h}_{{n}^{′}} s ( m Δ t , ( 2 Mn - 2 {n}^{′} ) Δ x ) , \qquad Eq . 3$$

where “q(mΔt,(2Mn+1)Δx” represents the down sampled signal. It is noted that the spacing between each sample of the q(mΔt,(2Mn+1)Δx) signal is 2MΔx. To compute the q(mΔt,(2Mn+1)Δx) signal at this spacing, every even indexed trace of the s(mΔt,nΔx) signal and additionally one odd indexed trace at every 2M+1 trace is used. As a result, the downsampling correspondingly increases the spacing of the particle motion sensors 58 along the streamer 30

For the example above, the sensor spacing MΔx is smaller than the maximum sensor spacing required for acquiring an unaliased signal. Therefore, further noise attenuation may be achieved by applying, for example, a frequency-wavenumber-selective time-space filter, called a “TX filter” herein. The TX filter, in general, removes noise above a certain velocity. Applying the TX filter to the downsampled signal results in a signal whose f-k space appears in FIG. 10. Mathematically, the application of the TX filter to the q(mΔt,(2Mn+1)Δx) downsampled signal may be described as follows:

$$r ( m Δ t , ( 2 nM + 1 ) Δ x ) = {\sum }_{{m}^{′} , {n}^{′}} {H}_{m - {m}^{′} , n - {n}^{′}} q ( {m}^{′} Δ t , ( 2 {n}^{′} M + 1 ) Δ x ) , \qquad Eq . 4$$

where “r(mΔt,(2nM+1)Δx” represents the output signal of the TX filter; “Δt” represents the sampling interval in time; and “H_{m,n}” represents the m-th and n-th space coefficient of the TX filter.

It is noted that the application of a TX filter illustrates one of many types of techniques that may be used to further attenuate the noise. For instance, noise attenuation algorithms such as LACONA, FX-IIR, VLSF, MSL or MSNA may be used in other embodiments of the invention.

The above-described processing of the particle motion data allows aliased vibration noise to enter the signal cone 104 in certain frequency bands. For the example above, these bands were the bands above approximately 80 Hz and approximately below 50 Hz. However, as described below, additional processing may be used to reconstruct a composite signal that has no aliased vibration noise in these bands, although this other signal does have aliased vibration noise in the 50 to 80 Hz band. As further described below, this other signal may be combined with the r(mΔt,(2nM+1)Δx) signal to produce a composite signal that does not have aliased vibration noise in any of the above-mentioned three frequency bands.

The processing to remove aliased vibration noise in the bands below 50 Hz and above 80 Hz may be described as follows for a particular example. As illustrated in FIG. 4, although a signal that is formed from uniformly spaced samples that are not close enough may result in vibration noise being aliased into the signal cone 104, the aliased vibration noise does not extend into all frequency bands. For the example that is depicted in FIG. 4, the uniform sampling interval was 2Δx. Although the vibration noise is aliased into the signal cone 104 (see reference numeral 118) at around 60 Hz, the vibration noise is not aliased into the signal cone 104 above 80 Hz or below 50 Hz. Therefore, a signal that is derived from uniform sampling at the 2Δx interval may be used, as described below, to recover the sensed particle motion without aliased vibration noise in the frequency bands above 80 Hz and below 50 Hz.

Because the sensor spacing 2Δx is smaller than the maximum sensor spacing required for acquiring an unaliased signal, further noise attenuation may be achieved for instance, by using a TX filter. A linear phase TX filter with an even number of spatial coefficients produces an output signal at an offset of (2n+1)Δx. Because the signal provided by this TX filter is oversampled and the noise outside the signal cone has been removed by the TX filter, the TX filter output may be downsampled to offsets of (2Mn+1)Δx. Mathematically, the TX filtering and downsampling operations may be expressed as follows:

$$u ( m Δ t , ( 2 Mn + 1 ) Δ x ) = {\sum }_{{m}^{′} , {n}^{′}} {G}_{m - {m}^{′} , 2 Mn - {n}^{′}} s ( {m}^{′} Δ t , 2 {n}^{′} Δ x ) , \qquad Eq . 5$$

where “u(mΔt,(2Mn+1)Δx)” represents the resulting signal; and “G_{m,n}” represents the m-th time and n-th space coefficient of the TX filter.

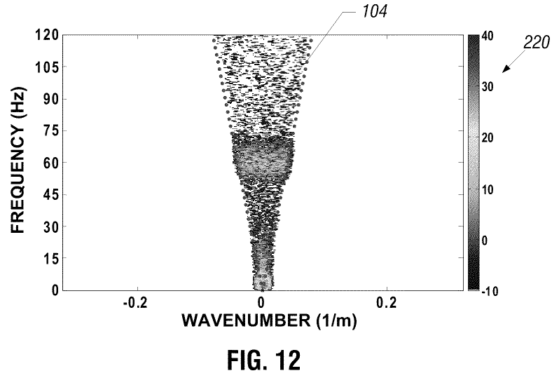

FIG. 12 is an illustration 220 representing the f-k spectrum of the u(mΔt,(2Mn+1)Δx) signal for the example contained herein. In this example, the TX filter removes noise with velocity less than 1500 m/s. As shown, the signal cone 104 contains aliased vibration noise in the 50 to 80 Hz frequency band but does not contain aliased vibration noise above approximately 80 Hz or below approximately 50 Hz.

It is noted that other noise attenuation methods other than the above-described above that applies the TX filter may be used. For example, in accordance with other embodiments of the invention, noise attenuation techniques such as LACONA, FX-IIR, VLSF, MSL or MSNA may be used for purpose of removing noise below a certain velocity.

The r(mΔt,(2nM+1)Δx) and u(mΔt,(2Mn+1)Δx) signals may be combined into a single signal, called “v(mΔt,(2Mn+1)Δx),” which contains substantially no aliased vibration noise (if any) in the signal cone 104 using a technique such as one that applies a quadrature mirror filter (QMF) bank. In this merger, the frequency bands of the u(mΔt,(2Mn+1)Δx) signal in which no vibration noise aliasing occurs are merged with the frequency band of the r(mΔt,(2nM+1)Δx) signal in which no vibration aliasing occurs to produce the r(mΔt,(2nM+1)Δx) signal in which substantially no aliased vibration noise is present in the signal cone 104.

As an example of this approach, both the r(mΔt,(2nM+1)Δx) and u(mΔt,(2Mn+1)Δx) signals may be split into aliased and non-aliased frequency bands by using a QMF decomposition tree. The unaliased frequency bands from the respective decomposition trees are combined to form another QMF decomposition tree, which contains only unaliased frequency bands. The unaliased frequency bands are then used to synthesize the full, unaliased frequency band of the v(mΔt,(2Mn+1)Δx) signal by using a QMF reconstruction technique.

The unaliased frequency bands may be combined using other techniques, in accordance with other embodiments of the invention.

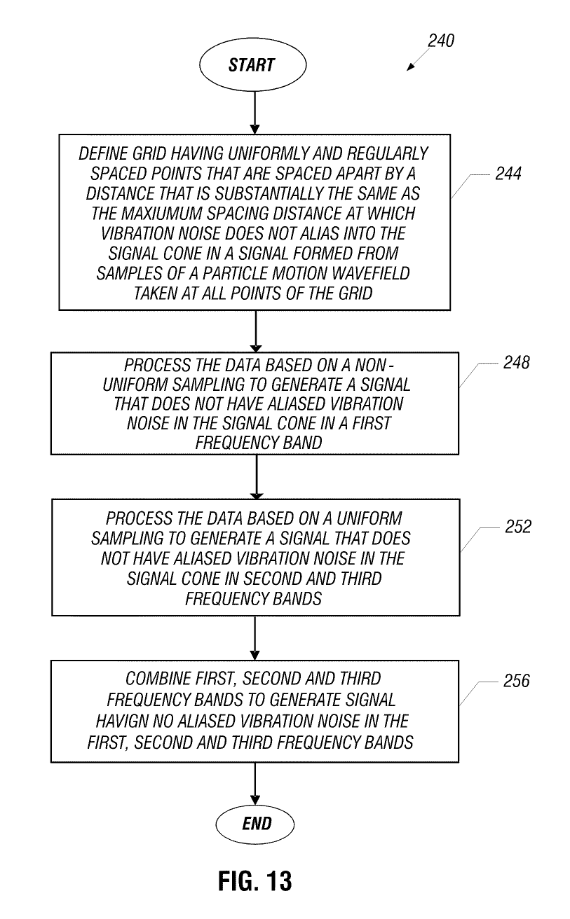

Referring to FIG. 13, thus, in accordance with embodiments of the invention, a technique 240 may be used for purposes of obtaining a signal in which vibration noise is not aliased in the signal cone. The technique 240 includes providing (block 244) a grid that has uniformly and regularly spaced points that are spaced apart by a distance that is substantially the same as the maximum spacing distance at which vibration noise does not alias into the signal cone in a signal that is formed from samples of a particle motion wavefield, which are taken at all points of the grid. Next, the particle motion data is processed (block 248) based on a non-uniform sampling to generate a signal that does not have aliased vibration noise in the signal cone at a first frequency subband. The particle motion data is also processed (block 252) based on a uniform sampling to generate another signal that does not have aliased vibration noise in the signal cone at second and third frequency bands. The first, second and third frequency bands are then combined, pursuant to block 256, to construct a signal that has the sensed particle motion signal without aliased vibration noise in the first, second and third frequency bands.

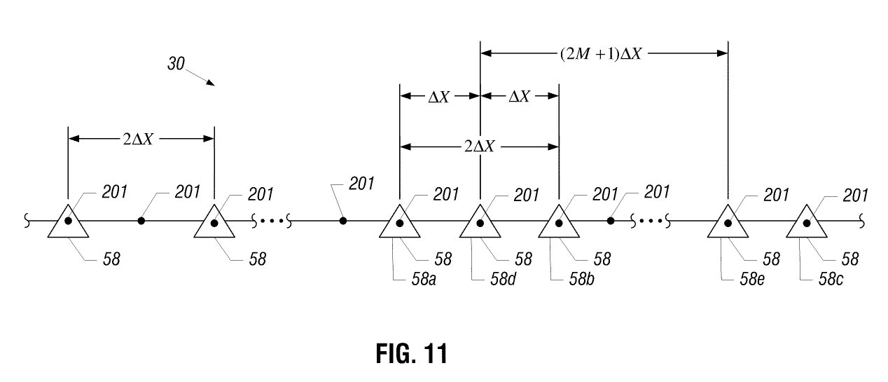

Referring to FIG. 11, using the regular and non-uniform processing of particle motion measurements, as described herein, a streamer 30 may be constructed as follows. In general, the streamer 30 has particle motion sensors 58, which are spaced at points 201 of a grid, which is defined by a regular spacing Δx. The particle motion sensors 58 are, in general, spaced at every other point 201 on this grid (called the “even indices” for this example) as illustrated, for example, by exemplary particle motion sensors 58a, 58b and 58c. As such, the particle motion sensors 58 are, in general, spaced apart by 2Δx. However, not all of the particle motion sensors 58 are spaced apart by the 2Δx spacing interval, as particle motion sensors 58 are also spaced at certain odd indices of the grid at a spacing of (2Mn+1)Δx, as illustrated by exemplary particle motion sensors 58d and 58e.

Thus, to summarize, to compute the q(mΔt,(2Mn+1)Δx) signal, every even index trace of the s(mΔt,nΔx) signal is needed and additionally, one odd index to trace at every (2Mn+1)Δx index of the s(mΔt,nΔx) signal is needed. To determine the u(mΔt,(2Mn+1)Δx) signal, only the even index traces of the s(mΔt,nΔx) signal is needed.

Therefore, the average sensor spacing interval for the traces, which are needed to compute q(mΔt,(2Mn+1)Δx) and u(mΔt,(2Mn+1)Δx) may be described as follows:

Δ x̅=2MΔx/(M+1), Eq. 6

wherein “Δ x̅” represents the average particle motion sensor spacing interval along the streamer 30.

As a specific example, the downsampling factor M may be 4 and Δx may be 39 1/16 centimeters (cm). For these parameters, the corresponding Δx average spacing interval is 62.5 cm; and the computed traces of the v(mΔt,(2Mn+1)Δx) signal is 3.125 m. As another example, the downsampling factor M may be 8, and the v(mΔt,(2Mn+1)Δx) signal may be computed at every 6.25 m. This produces an Δ x̅ average sensor spacing interval of 69 4/9 cm. Other downsampling factors, output spacing intervals, etc., may be used in accordance with other embodiments of the invention,

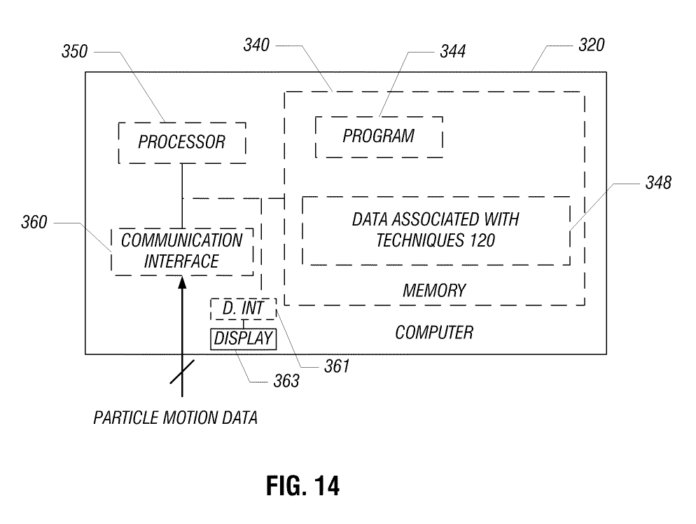

Referring to FIG. 14, in accordance with some embodiments of the invention, a processing system 320 may perform at least part of one or more of the techniques that are disclosed herein, such as techniques 130 and/or 240.

The system 320 may be located on one of the streamers 30, on each streamer 30, distributed among the streamers 30, on the seismic source 40, on the survey vessel 20, at a remote land-based facility, etc. The system 320 may also be distributed on one or more of these entities, in accordance with other embodiments of the invention. In accordance with some embodiments of the invention, the system 320 may include a processor 350, such as one or more microprocessors and/or microcontrollers.

The processor 350 may be coupled to a communication interface 360 for purposes of receiving seismic data, which are indicative of seismic measurements. For example, the communication interface 360 may receive at least particle motion data, which are indicative of the measurements of a particle motion wavefield, which are acquired by the particle motion sensors 58.

As a non-limiting example, the interface 360 may be a USB serial bus interface, a network interface, a removable media (such as a flash card, CD-ROM, etc.) interface or a magnetic storage interface (IDE or SCSI interfaces, as examples). Thus, the interface 360 may take on numerous forms, depending on the particular embodiment of the invention.

In accordance with some embodiments of the invention, the interface 360 may be coupled to a memory 340 of the system 320 and may store, for example, various input and/or output data sets 348 involved with the techniques that are described herein. The memory 340 may store program instructions 344, which when executed by the processor 350, may cause the processor 350 to perform at least part and possibly all of one or more of the techniques that are described herein and display results obtained via the technique(s) on the display 374 of the system 320, in accordance with some embodiments of the invention. As shown in FIG. 14, the system 320 may include a display interface 370 that couples the display device 374 to the system 320.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

What is claimed is:

1. A method comprising:
receiving data indicative of non-uniformly spaced samples of particle motion wavefield acquired by particle motion sensors while in tow, the samples being spaced apart by an average spacing interval and the average spacing interval not being small enough to prevent vibration noise from being aliased into a signal cone in a first signal formed from samples of the particle motion wavefield having a uniform spacing at the average spacing interval; and
processing the data to generate a second signal indicative of the particle motion wavefield and not having vibration noise aliased into the signal cone.

2. The method of claim 1, wherein the samples indicated by the data are associated with alternating points of a uniform grid and points of the uniform grid associated with locations of the second signal.

3. The method of claim 1, wherein the processing includes:
applying a half band filter to the data.

4. The method of claim 3, wherein the processing further includes:
downsampling the filtered data to generate downsampled data.

5. The method of claim 4, wherein the processing further includes:
frequency-wavenumber filtering the downsampled data.

6. The method of claim 1, wherein the processing comprises:
processing the data based on a non-uniform sampling to generate a third signal containing a first frequency band in which aliased vibration noise does not enter the signal cone;
processing the data to based on a uniform sampling to generate a fourth signal containing second and third frequency bands in which vibration noise does not enter the signal cone;
combining the first, second and third frequency bands to generate the second signal.

7. An article comprising a computer readable storage medium to store instructions that when executed by a computer cause the computer to:
receive data indicative of non-uniformly spaced samples of particle motion wavefield acquired by particle motion sensors while in tow, the samples being spaced apart by an average spacing interval and the average spacing interval not being small enough to prevent vibration noise from being aliased into a signal cone in a first signal formed from samples of the particle motion wavefield having a uniform spacing at the average spacing interval; and
process the data to generate a second signal indicative of the particle motion wavefield and not having vibration noise aliased into the signal cone.

8. The article of claim 7, wherein the samples indicated by the data are associated with alternating points of a uniform grid and points of the uniform grid associated with locations of the second signal.

9. The article of claim 7, the storage medium storing instructions to cause the computer to apply a half band filter to the data to generate filtered data.

10. The article of claim 9, the storage medium storing instructions to cause the computer to downsample the filtered data to generate downsampled data.

11. The article of claim 10, the storage medium storing instructions that when executed cause the computer to frequency-wavenumber filter the downsampled data.

12. The article of claim 10, the storage medium storing instructions that when executed cause the computer to:
process the data based on a non-uniform sampling to generate a third signal containing a first frequency band in which aliased vibration noise does not enter the signal cone;
process the data to based on a uniform sampling to generate a fourth signal containing second and third frequency bands in which vibration noise does not enter the signal cone; and
combine the first, second and third frequency bands to generate the second signal.

13. A system comprising:
an interface to receive data indicative of non-uniformly spaced samples of particle motion wavefield acquired by particle motion sensors while in tow, the samples being spaced apart by an average spacing interval and the average spacing interval not being small enough to prevent vibration noise from being aliased into a signal cone in a first signal formed from samples of the particle motion wavefield having a uniform spacing at the average spacing interval; and
a process to process the data to generate a second signal indicative of the particle motion wavefield and not having vibration noise aliased into the signal cone.

14. The system of claim 13, wherein the samples indicated by the data are associated with alternating points of a uniform grid and points of the uniform grid associated with locations of the second signal.

15. The system of claim 13, wherein the processor is adapted to apply a half band filter to the data to generate filtered data.

16. The system of claim 13, wherein the processor is adapted to downsample the filtered data to generate downsampled data.

17. The system of claim 13, wherein the processor is adapted to frequency-wavenumber filter the downsampled data.

18. The system of claim 13, wherein the processor is adapted to:
process the data based on a non-uniform sampling to generate a third signal containing a first frequency band in which aliased vibration noise does not enter the signal cone;
process the data to based on a uniform sampling to generate a fourth signal containing second and third frequency bands in which vibration noise does not enter the signal cone; and
combine the first, second and third frequency bands to generate the second signal.

19. A system comprising:
a streamer; and
particle motion sensors non-uniformly spaced apart along the streamer by an average spacing interval, the average spacing interval not being small enough to prevent vibration noise from being aliased into a signal cone in a signal formed from samples of the particle motion wavefield having a uniform spacing at the average spacing interval.

20. The system of claim 19, wherein
a first group of the particle motion sensors are disposed at alternating locations of a uniform grid, and
each sensor of a second group of the particle motion sensors are disposed at locations between two of the alternating locations.

21. The system of claim 20, wherein each sensor of the second group of particle motion sensors is disposed at location at which the seismic signal is to be reconstructed.

22. The system of claim 19, further comprising:
a vessel to tow the streamer.
